(19) United States
(12) Patent Application Publication
(10) Pub. No.: US 2006/0187471 A1
(43) Pub. Date: Aug. 24, 2006

(54) Print data compiling device and method, print data compiling program, and printing method

(75) Inventor: Satoshi Ohmori, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/223,004

(22) Filed: Sep. 12, 2005

(30) Foreign Application Priority Data
Feb. 24, 2005 (JP) 2005-049281

(51) Int. Cl. G06K 15/02; G06F 15/00

(52) U.S. Cl. 358/1.2; 358/450

(57) ABSTRACT

A print data compiling device has a first unit, a second unit and a compiling unit. The first unit specifies a size of an original arbitrarily. The second unit divides image generated based on image data. The image data is generated based on a size of paper on which the image is to be printed and the specified original size. The compiling unit compiles print data for printing the divided image on the paper, based on the size of paper, the image data, and the divided image.

### CROSS-REFERENCE TO RELATED APPLICATION

This application claims priority under 35USC 119 from Japanese Patent Application No. 2005-49281, the disclosure of which is incorporated by reference herein.

### FIELD OF THE INVENTION

The present invention relates to print data compiling device and method, print data compiling program, and printing method, and more particularly to print data compiling device and method, print data compiling program, and printing method capable of specifying a size of paper on which an image is to be printed.

### DESCRIPTION OF THE RELATED ART

Conventionally, the original size when compiling a document according to a document compiling program is specified individually or initially within a predetermined standard size in the document compiling program, and the user compiles a document according to the specified original size. When printing the compiled document, the user starts up a printer driver. The printer driver specifies the paper size to conform to the original size. Therefore, the user commands start of a printing process without particularly checking the paper size (see user manual for “DocuCentre Color a450P/a250P” manufactured by Fuji Xerox Co., Ltd.).

Incidentally, the original size in the document compiling program is not always linked to the paper size assumed in the printer driver (the paper size loaded in the printer, for example, B5 only). Therefore, if the original size (for example, A4) is other than the size assumed in the printer (B5), an error is displayed. In such a case, the user specifies a size (B5) that is different from the original size (A4), and the original image is output by reduction (A4 to B5). In this case, therefore, an image of the specified original size (A4) is not obtained.

The original size in this case is within a standard size, but the user can freely specify a size other than a standard size as the original size. Even in this case, the original size to be specified by the user can not be larger than the applicable paper size in the printer driver.

Such conventional technology is not convenient for the user because it is not applicable when the user specifies the original size arbitrarily and it is larger than the applicable paper size in the printer driver.

### SUMMARY OF THE INVENTION

The present invention has been made in view of the above circumstances and provides a print data compiling device and method, print data compiling program, and printing method capable of enhancing the convenience for the user.

According to an aspect of the invention, the print data compiling device has a first unit, a second unit and a compiling unit. The first unit specifies a size of an original arbitrarily. The second unit divides image generated based on image data. The image data is generated based on a size of paper on which the image is to be printed and the specified original size. The compiling unit compiles print data for printing the divided image on the paper, based on the size of paper, the image data, and the divided image.

### BRIEF DESCRIPTION OF THE DRAWINGS

Embodiments of the present invention will be described in detail based on the following figures, wherein:

FIG. 1 is a block diagram of a print system having a printer and plural clients;

FIG. 2 is a block diagram of a client;

FIG. 3 is a flowchart of a print data compiling program;

FIG. 4 is a diagram illustrating a print setting screen of a printer;

FIG. 5 is a diagram illustrating a menu for specifying a size of an original arbitrarily;

FIG. 6 is a diagram illustrating a user definition screen for specifying a size of an original arbitrarily;

FIG. 7 is a flowchart showing the details of step 53 in FIG. 3;

FIG. 8 is a diagram showing another example of a print setting screen of a printer; and

FIG. 9 is a diagram illustrating a detail setting screen.

### DETAILED DESCRIPTION OF THE INVENTION

Embodiments of the present invention are described in detail below with reference to the accompanying drawings.

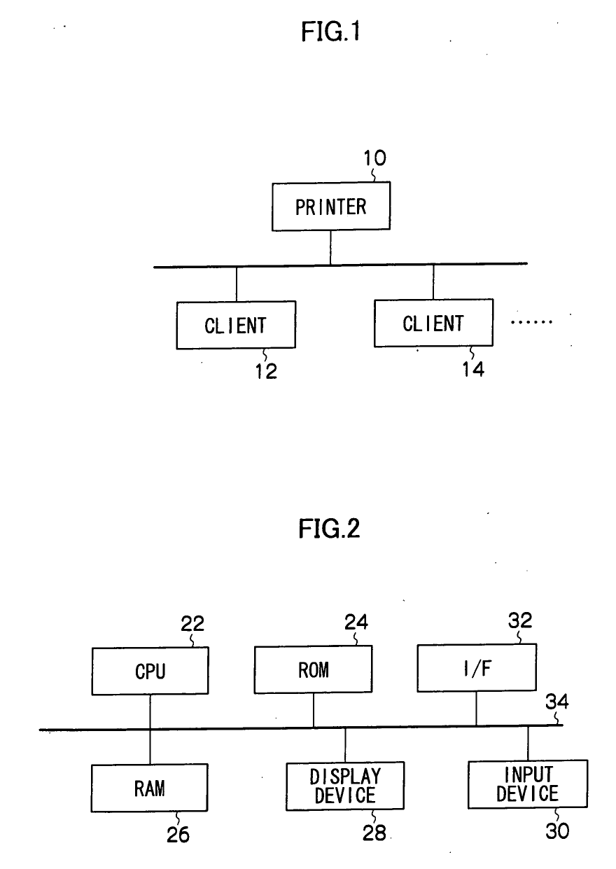

As shown in FIG. 1, a printer 10 as printing unit is connected to a document compiling device (personal computer), image data compiling unit, and plural clients 12, 14, . . . as print data compiling devices.

Since the plural clients 12, 14, . . . are identical in configuration, the client 12 is explained as a representative example.

As shown in FIG. 2, the client 12 comprises a CPU 22, a ROM 24 storing a print data compiling program, a document compiling program and the like, a RAM 26, a display device 28 as a display unit, an input device 30 comprising a mouse, a keyboard and the like, and an interface (I/F) 32 connected to the printer 10 by way of a network, which are mutually connected by way of a bus 34.

Next, the operation of the embodiment will be described.

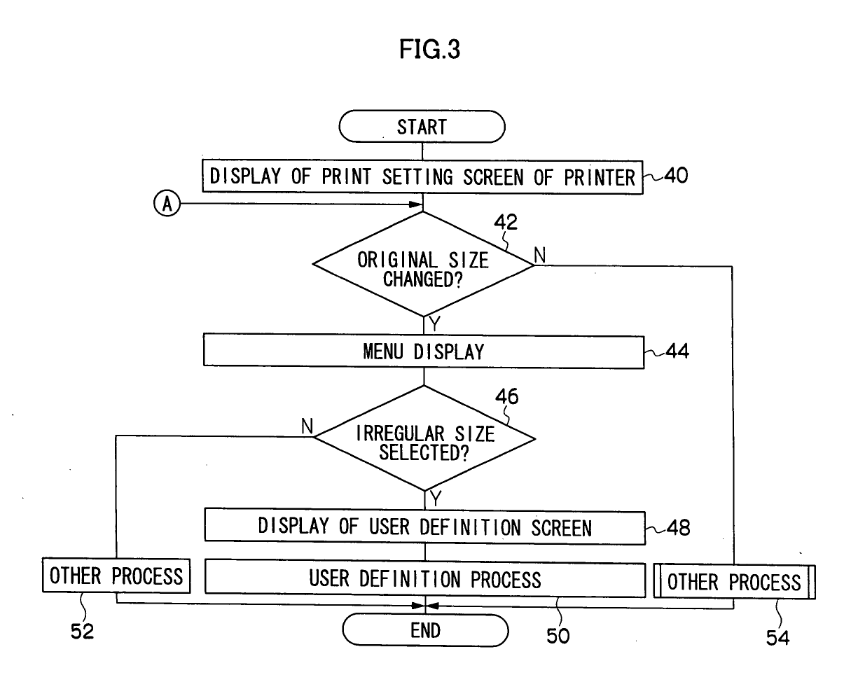

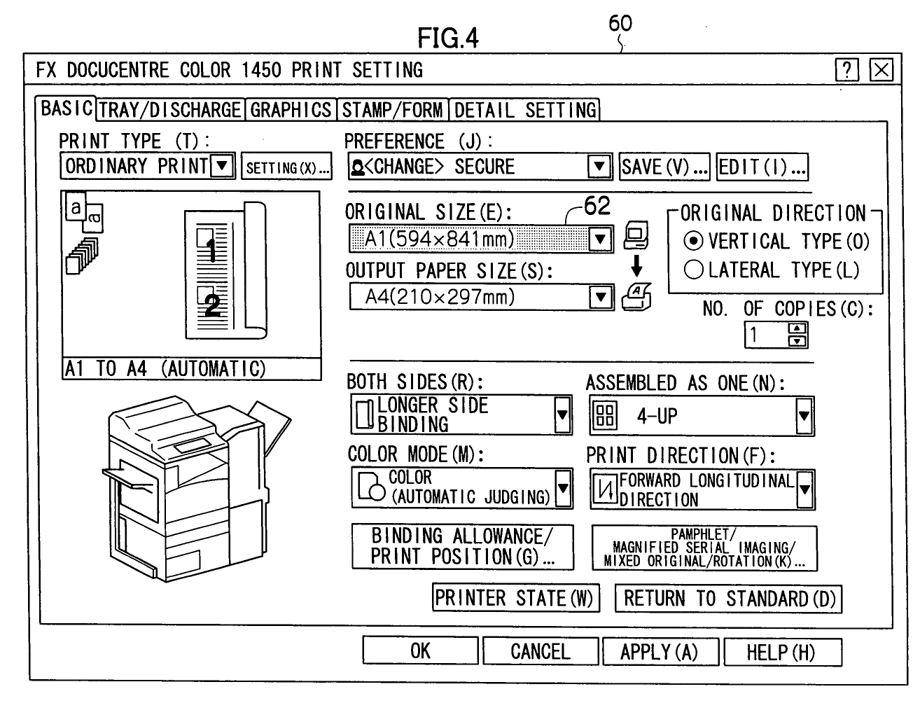

As shown in FIG. 3, when the user desires to compile a document in the client 12 by starting up the document compiling program, a print instruction button (not shown) is pressed, and the print data compiling program shown in FIG. 3 starts. At step 40, a print setting screen 60, such as shown in FIG. 4, of the printer 10 is displayed.

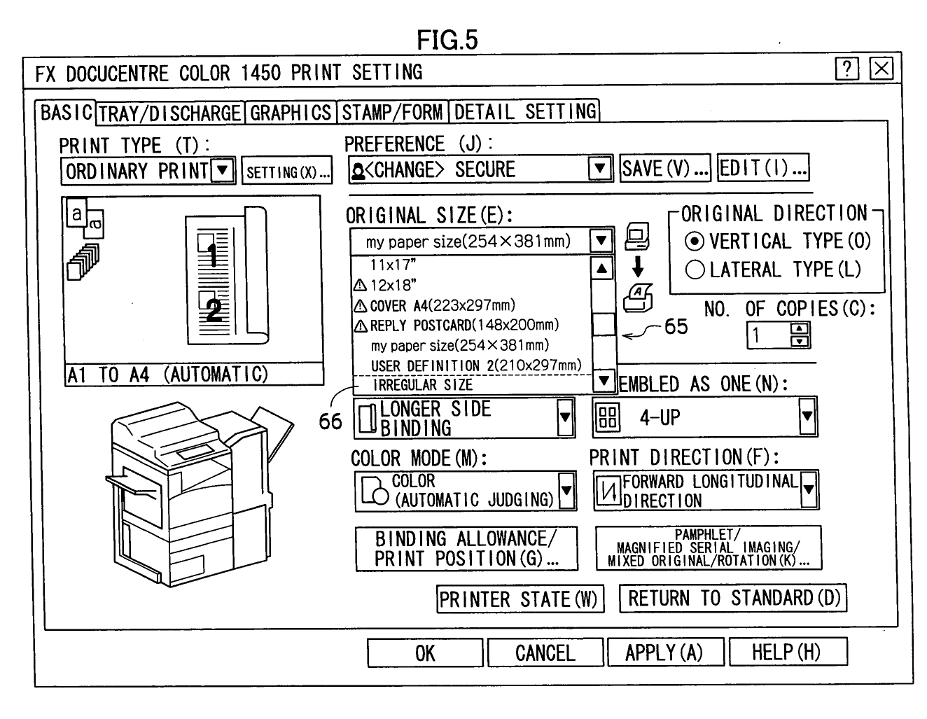

In FIG. 4, the print setting screen 60 has an input unit 62 for specifying a size of an original arbitrarily, and when the input unit 62 is clicked by using a mouse, step 42 is judged affirmatively, and a menu (drop-down list) 65, such as shown in FIG. 5, is displayed at step 44. This menu has a menu of plural predetermined standard sizes and sizes defined by the user and an irregular size menu 66 for the user to newly specify a size arbitrarily.

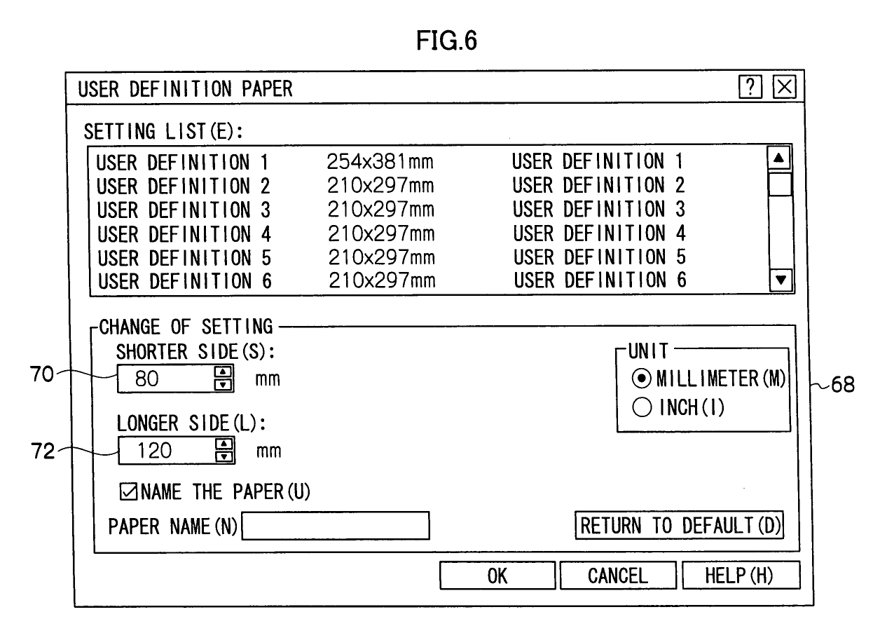

When the irregular size menu 66 is selected, step 46 is judged affirmatively, and a user definition screen 68 is displayed as shown in FIG. 6 at step 48. As shown in FIG. 6, the user definition screen 68 has input units 70 and 72 for specifying the original size, that is, the input unit 70 for specifying length of the shorter side, and the input unit 72 for specifying the length of the longer side. The input units 70 and 72 constitute the first specifying unit.

To specify the original size arbitrarily, the user specifies the length of the shorter side in the input unit 70, and the length of the longer side in the input unit 72. As a result, the original size is specified arbitrarily by the user. For example, the user can specify the original size as 80×120. The defined original size can be identified with a name (identification information) by the user by entering a predetermined name in an input unit 75. For example, “poster” is entered.

At step 42, if it is judged that the original size is not to be changed, other processes (described later in detail) are executed at step 54.

At step 46, if irregular size is not selected, that is, if a regular size is selected, other processes for setting the original size as a regular size are executed at step 52.

Thus, after the original size is specified, the print data compiling program is once terminated, and the user compiles a document (image data) according to the document compiling program.

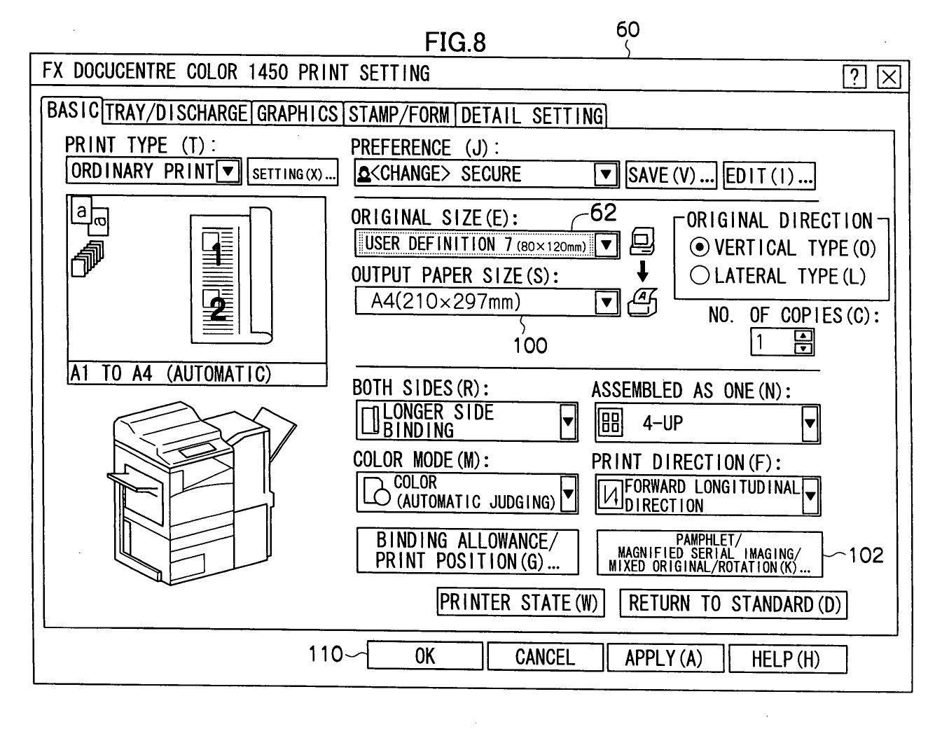

When the print instruction button is pressed to print the compiled document, the print data compiling program starts again, and the print setting screen 60 of the printer is displayed at step 40 as described above. In this case, as shown in FIG. 8, the document of user definition 7 (or “poster”) (80×120 mm), which has been defined as described above, is specified in the input unit 62.

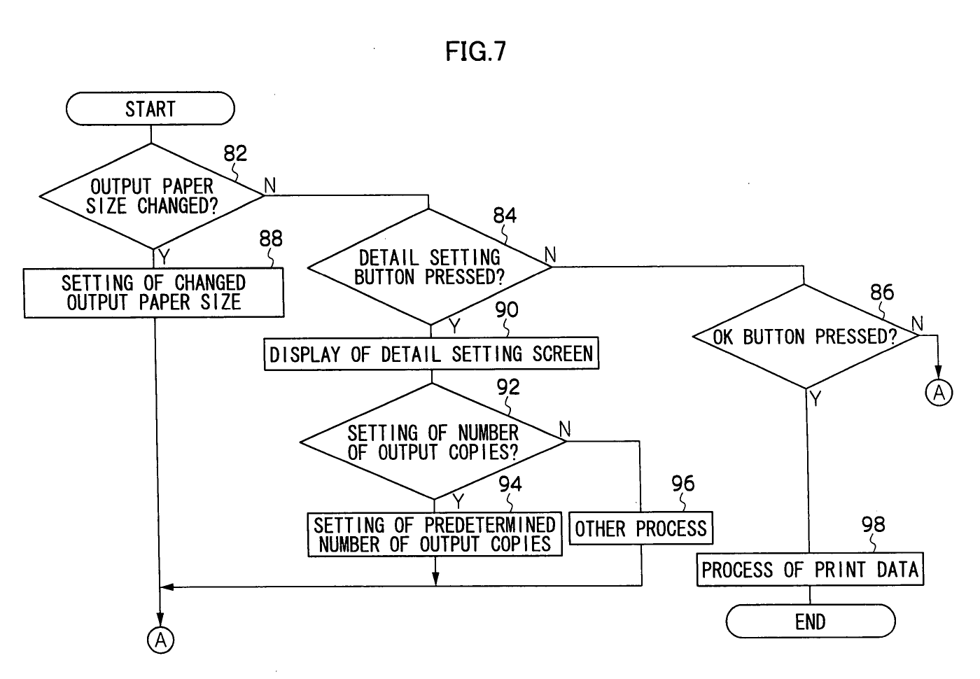

When step 42 is judged negatively, other processes at step 54 are executed. These processes (step 54) are described in detail by referring to FIG. 7.

At step 82, it is judged whether the output paper size is to be changed or not. That is, the setting screen 60 of the printer has an input unit 100 for specifying an output paper size as shown also in FIG. 8. When the user clicks the input unit 100 by using the mouse, step 82 is judged affirmatively, and the changed output paper size, for example, A4 is set at step 88.

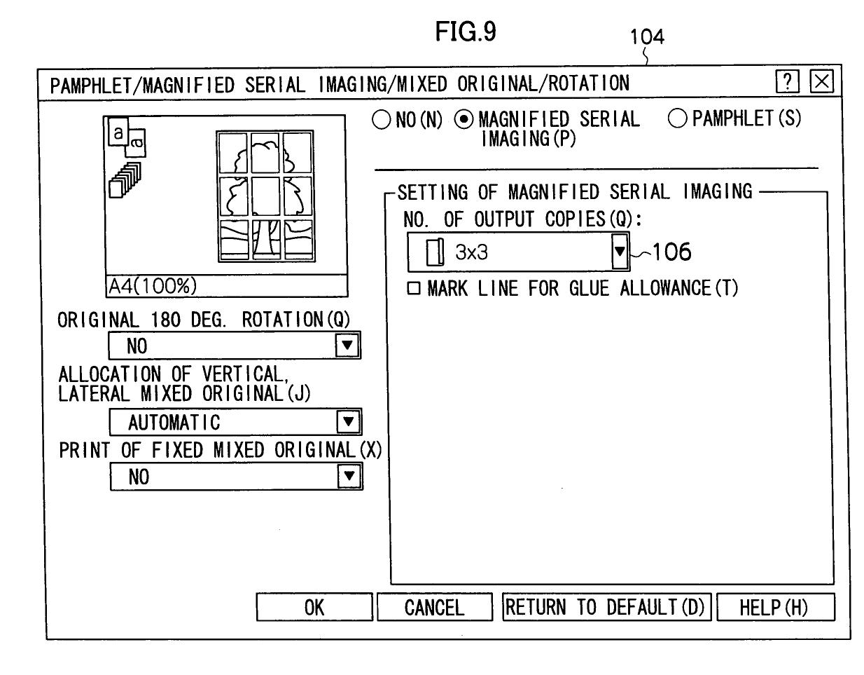

At step 82, on the other hand, if it is judged that the output paper size is not to be changed, it is judged at step 84 whether the detail setting button is pressed or not. That is, as shown in FIG. 8, the print setting screen 60 of printer has a detail setting button 102, and when this detail setting button 102 is clicked by the user by using the mouse, step 84 is judged affirmatively, and a detail setting screen 104 is displayed as shown in FIG. 9 at step 90.

The detail setting screen 104 has an input unit 106 for entering the number of output copies as shown in FIG. 9. The input unit 106 constitutes the second specifying unit. The number of output copies is for specifying the mode of dividing the image of the size arbitrarily specified by the user. FIG. 9 shows an example of dividing the original (80×120) in a mode of 3×3. Generally, the original is divided by integer×integer.

When the image dividing mode is specified by the input unit 106, step 92 is judged affirmatively, and the specified number of output copies (mode of dividing) is set at step 94. If step 92 is judged negatively, other processes (rotation of original, etc.) are executed at step 96.

If step 84 is judged negatively, it is judged at step 86 whether or not an OK button has been pressed. As shown in FIG. 8, when the OK button 110 is pressed, step 98 is executed to compile print data for printing images divided according to the specified process on the paper of the specified size, on the basis of the compiled document (image data), the specified paper size, and the specified image dividing mode (number of output copies).

Then, the compiled print data is transmitted to the printer 10. The printer 10 receives the print data, and prints the images divided according to the specified mode on the paper of the specified size.

As described above, if an original image not conforming to a predetermined standard size is specified arbitrarily and even if a paper size smaller than the specified original size is specified, images divided according to the specified mode can be printed on the specified paper, so that the degree of freedom for the user can be enhanced.

In other words, the original region can be set arbitrarily as desired. That is, by setting the size by using the input unit, the range can be set independently in the vertical direction and the lateral direction and output can be carried out.

In magnified serial imaging, in a case where the output of the image exceeds the maximum output size of the printer, the original of the specified size can be preliminarily registered and compiled as a virtual irregular size.

At the time of output, a desired output can be obtained easily by specifying a multiplying factor of 100% in the necessary magnified serial imaging setting.

As mentioned above, the print data compiling device in an aspect of the invention includes: specifying unit for specifying a size of an original arbitrarily; a second specifying unit for specifying a size of paper on which an image is to be printed, and a mode of dividing the image on the basis of image data compiled according to the specified original size; and a compiling unit for compiling print data for printing images divided according to the specified mode on the paper of the specified size, on the basis of the image data, the specified paper size, and the specified mode of dividing the image.

The first specifying unit specifies the original size arbitrarily. That is, the first specifying unit can specify not only a predetermined standard size, but also can specify another original size, as desired, not conforming to the predetermined standard size.

The second specifying unit specifies a size of paper on which an image is to be printed, and a mode of dividing the image on the basis of image data compiled according to the specified original size.

More specifically, if the original size arbitrarily specified by the first specifying unit is larger than the paper size specified by the second specifying unit, all of the image on the basis of image data compiled according to the specified original size cannot be printed within the specified paper size.

In such a case, conventionally, the user compiles image data in a predetermined standard size, specifies a multiplying factor to magnify, and specifies the mode of dividing the image on the basis of image data compiled according to the specified original size by the second specifying unit, thereby producing output.

However, the original size cannot be specified and the image data to be output cannot be compiled in the size desired by the user.

Accordingly, the first specifying unit makes it possible to specify the same size as the size desired by the user as the original size. The compiling unit compiles print data for printing the images divided according to the specified mode on the paper of the specified size, on the basis of the image data, the specified paper size, and the specified mode of dividing the image.

Hence, if an original size not conforming to a predetermined standard size is specified as the original size and a paper size smaller than the original size is specified, print data is compiled for printing images divided according to the specified mode on the paper of the specified size. Accordingly, on the basis of the print data, the divided images can be printed on the specified paper. As a result, the degree of freedom for the user can be enhanced.

The original size, paper size, and image dividing mode may be individually entered and specified by the user, but this is complicated.

The print data compiling device of may further includes a display unit for displaying the original size, paper size, and image dividing mode, wherein the first specifying unit and second specifying unit are operated by using the display unit (second aspect).

As a result, the convenience for the user can be enhanced.

A print data compiling method according to a third aspect and a print data compiling program according to a fourth aspect of the invention have the same action and effects as mentioned above, and therefore explanation thereof is omitted.

The invention also provides the following print data compiling device (fourth aspect). The print data compiling device includes: a first specifying unit for specifying an arbitrary size not conforming to a predetermined standard size as a size of an original; a second specifying unit for specifying a size smaller than the specified size as a size of paper on which an image is to be printed, and a mode of dividing the image on the basis of image data compiled according to the specified original size; and a compiling unit for compiling print data for printing images divided according to the specified mode on the paper of the specified size, on the basis of the image data, specified paper size, and specified mode of dividing the image.

A fifth aspect of the invention is to provide a printing method including: specifying a size of an original arbitrarily, by a first specifying unit; compiling image data according to the specified original size, by an image data compiling unit; specifying a size of paper on which an image is to be printed, and a mode of dividing the image on the basis of the image data compiled according to the specified original size, by a second specifying unit; and printing images divided according to the specified mode on the paper of the specified size, on the basis of the image data, the specified paper size, and the specified mode of dividing the image, by a printing unit.

That is, the user can specify the original size as desired through the first specifying unit.

The image data compiling unit such as a document compiling device (personal computer, etc.) compiles image data according to the specified original size.

The user also specifies a size of paper on which an image is to be printed, and a mode of dividing the image on the basis of the image data compiled according to the specified original size through the second specifying unit.

The printing unit of an image printing device (device having a printing function) prints the images divided according to the specified mode on the paper of the specified size, on the basis of the image data, specified paper size, and specified mode of dividing the image.

Thus, if an original size is specified arbitrarily and a paper size smaller than the specified original size is specified, the images divided according to the specified mode can be printed on the specified paper, so that the degree of freedom for the user can be enhanced.

As described above, according to the invention, if an original size not conforming to a predetermined standard size is specified arbitrarily and a paper size smaller than the specified original size is specified, the images divided according to the specified mode can be printed on the specified size, so that the degree of freedom for the user can be enhanced.

The present invention has been described above, but the present invention is not limited to that description. In addition, various modifications and changes of the invention can be made without departing from the spirit and scope of the invention.

What is claimed is:

1. A print data compiling device comprising:
a first unit that specifies a size of an original arbitrarily;
a second unit that divides image generated based on image data, the image data being generated based on a size of paper on which the image is to be printed and the specified original size; and
a compiling unit that compiles print data for printing the divided image on the paper, based on the size of paper, the image data, and the divided image.

2. The print data compiling device according to claim 1, further comprising:
a display that displays the original size, paper size, and a mode of dividing the image, wherein the first unit and second unit are operated by using the display.

3. The print data compiling device according to claim 1, wherein a mode of dividing the image is specified by specifying the number of output copies.

4. The print data compiling device according to claim 1, wherein a mode of dividing the image is to divide the vertical size and lateral size of the original by an integer.

5. The print data compiling device according to claim 1, wherein when the first unit specifies an arbitrary size not conforming to a predetermined standard size as a size of an original, the second unit specifies a size smaller than the specified size as a size of paper on which an image is to be printed, and divides the image on the basis of image data compiled according to the specified original size.

6. A print data compiling method comprising:
specifying a size of an original arbitrarily;
dividing image generated based on image data, the image data being generated based on a size of paper on which the image is to be printed and the specified original size; and
compiling print data for printing the divided image on the paper, based on the size of paper, the image data, and the divided image.

7. The print data compiling method according to claim 6, wherein a mode of dividing is specified by specifying the number of output copies.

8. The print data compiling method according to claim 6, wherein a mode of dividing is to divide the vertical size and lateral size of the original by an integer.

9. A storage medium readable by a computer, the storage medium storing a program of instructions executable by the computer to perform a function for compiling print data, the function comprising:
specifying a size of an original arbitrarily;
dividing image generated based on image data, the image data being generated based on a size of paper on which the image is to be printed and the specified original size; and
compiling print data for printing the divided image on the paper, based on the size of paper, the image data, and the divided image.

10. The storage medium according to claim 9, wherein a mode of dividing the image is specified by specifying the number of output copies.

11. The storage medium according to claim 9, wherein a mode of dividing the image is to divide the vertical size and lateral size of the original by an integer.
